(19) United States
(12) Patent Application Publication
(10) Pub. No.: US 2008/0035550 A1
(43) Pub. Date: Feb. 14, 2008

(54) DEVICE, WITH A BACKUP FILTER, FOR PRODUCING STERILE LIQUID

(75) Inventors: Luciano FECONDINI, Bologna (IT); Giuseppe PALUMBO, Modena (IT)

Correspondence Address: ROGER PITT;KIRKPATRICK & LOCKHART PRESTON GATES ELLIS LLP, 599 LEXINGTON AVENUE, 33RD FLOOR, NEW YORK, NY, 10022-6030, US

(73) Assignee: MEDICA S.r.I., MEDOLLA (IT)

(21) Appl. No.: 11/835,851

(22) Filed: Aug. 8, 2007

(30) Foreign Application Priority Data
Aug. 9, 2006 (IT) BO2006A 000599

(51) Int. Cl. B01D 24/02

(52) U.S. Cl. 210/282

(57) ABSTRACT

The device has a cartridge defined by a central body, and by a first and second cover body closing the axial ends of the central body; a first fitting formed in the first cover body to permit liquid flow into the cartridge; a chamber defined between a plate installed at a first axial end of the central body, and the inner wall of the first cover body; a tube bundle defined by capillary fibres having first axial ends fitted to the plate and communicating hydraulically with the chamber, and occluded second axial ends located at the second cover body; a membrane housing the tube bundle; and a second fitting formed in the central body to permit outflow of the liquid which has undergone a first filtration through the thickness of the capillary fibres, and a second filtration through the membrane.

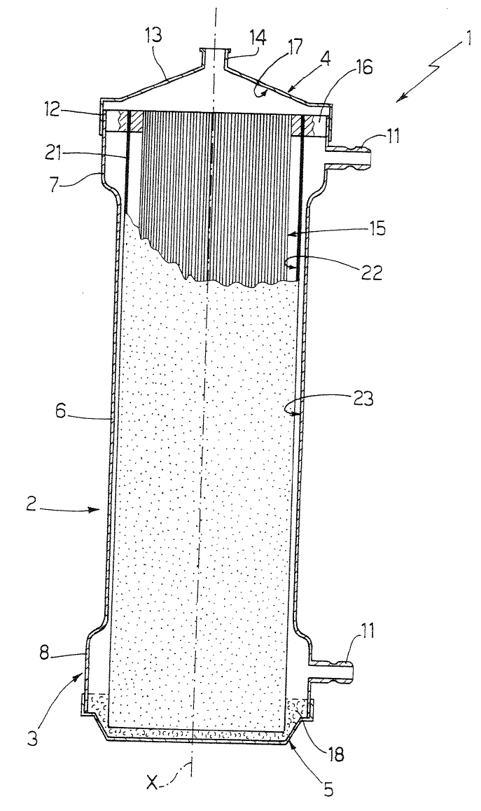

The present invention relates to a device for producing sterile liquid, such as infusion liquid, dialysis liquid, medical water-base solutions, wound-cleansing water, drinking water, laboratory or industrial water, etc.

### BACKGROUND OF THE INVENTION

As is known, sterile water for the above uses is increasingly difficult to procure, hence the increasing need to sterilize whatever water is available. Currently marketed filtration devices, however, are of complicated design, are expensive to manufacture, and therefore practically unmarketable in low-income areas where water processing is most needed.

### SUMMARY OF THE INVENTION

It is an object of the present invention to provide a liquid processing device, with a backup filter, designed to eliminate the aforementioned drawbacks, i.e. which provides for effective filtration, and is easy to use, straightforward in design, and cheap to manufacture.

According to the present invention, there is provided a device, with a backup filter, for producing sterile liquid, characterized by comprising:

a cartridge defined by a central body, and by a first and second cover body closing the axial ends of said central body;

a first fitting formed in said first cover body to permit liquid flow into said cartridge;

a first chamber defined between a plate installed at a first axial end of said central body, and the inner wall of said first cover body;

at least one tube bundle defined by a number of capillary fibres having first axial ends fitted to said plate and communicating hydraulically with said first chamber, and occluded second axial ends located at said second cover body;

at least one membrane housing said tube bundle; and

at least one second fitting formed in said central body to permit outflow of the liquid which has undergone a first filtration through the thickness of said capillary fibres, and a second filtration through said membrane.

### BRIEF DESCRIPTION OF THE DRAWING

The present invention will be described with reference to the attached drawing, which shows a partly sectioned view of a preferred embodiment of a device, with a backup filter, for producing sterile liquid.

### DETAILED DESCRIPTION OF THE INVENTION

The device, indicated as a whole by 1, comprises a cartridge 2 defined by a hollow, cylindrical central body 3, and by two cover bodies 4 and 5 closing the axial ends of central body 3. Cartridge 2 is preferably made of transparent plastic material. Along its longitudinal axis X, central body 3 comprises a central portion 6; and two axial end portions 7 and 8 having inside and outside diameters larger than those of central portion 6. And a respective processed-liquid outlet fitting 11 originates from each end portion 7, 8.

Cover body 4 comprises a cylindrical portion 12 fitted or screwed to end portion 7; and a truncated-cone-shaped portion 13, from the central portion of which an untreated-liquid inlet fitting 14 originates coaxially with axis X.

Device 1 also comprises a cylindrical tube bundle 15 coaxial with axis X and defined by a number of capillary fibres. The untreated liquid is fed into the capillary fibres and, as it flows through the thickness of the capillary fibres, undergoes a first filtration, or rather ultrafiltration, so the liquid issuing from tube bundle 15 is cleansed of all contaminating microorganisms, such as bacteria, viruses, and endotoxins. The capillary fibres are preferably made of polysulphone.

With reference to the attached drawing, a plate 16 is installed inside central body 3, at portion 7, and defines a chamber 17 with the inner surface of cover body 4. The capillary fibres of tube bundle 15 have first ends fitted to plate 16 and coming out inside chamber 17, so that the incoming liquid into chamber 17 is channeled into the capillary fibres. The opposite ends of the capillary fibres are closed by a layer 18 of resin formed at the attachment point of cover body 5 to end portion 8 of central body 3. Fittings 11 are obviously located in the space between plate 16 and layer 18.

A cylindrical sterilizing membrane 21, coaxial with longitudinal axis X, is also installed inside central body 3.

Membrane 21 is preferably made of preferably 0.2 μm thick polypropylene, and defines a second liquid filtration stage. Membrane 21 has a first axial end fitted to plate 16, and a second axial end fitted to layer 18, has an inside diameter larger than the diameter of tube bundle 15, so as to form a chamber 22 in between, and has an outside diameter smaller than the inside diameter of central portion 6 of body 3, so as to form an annular chamber 23 communicating hydraulically with the outside of cartridge 2 via fittings 11.

In actual use, the untreated liquid flows into cartridge 2—more specifically, into chamber 17—through fitting 14, and is normally injected by a pump (not shown) or other means, or even simply by the pressure of the liquid itself. From chamber 17, the liquid flows into the capillary fibres and, as it flows through the thickness of the fibres, undergoes a first filtration, as stated, to remove bacteria, viruses, and endotoxins. The liquid then flows out of the capillary fibres into chamber 22 and through membrane 21 into chamber 23. As it flows through the thickness of membrane 21, the liquid undergoes a second filtration to completely remove any bacteria escaping the first filtration, e.g. because of one or more damaged capillary fibres. In other words, membrane 21 constitutes an additional, final, backup filter for the liquid, which then flows from chamber 23 to the user device through fittings 11.

The advantages of the present invention will be clear from the foregoing description.

In particular, a device, with a backup filter, for producing sterile liquid is achieved, which is straightforward in design and cheap to produce, and which provides for two cascade filtration stages to effectively sterilize the liquid.

Clearly, changes may be made to device 1 as described and illustrated herein without, however, departing from the scope of the present invention.

In particular, a number of cascade membranes 21 may be provided, or a number of tube bundles 15, each housed inside a respective membrane 21.

1) A device, with a backup filter, for producing sterile liquid, characterized by comprising:
a cartridge (2) defined by a central body (3), and by a first (4) and second (5) cover body closing the axial ends of said central body (3);
a first fitting (14) formed in said first cover body (4) to permit liquid flow into said cartridge (2);
a first chamber (17) defined between a plate (16) installed at a first axial end of said central body (3), and the inner wall of said first cover body (4);
at least one tube bundle (15) defined by a number of capillary fibres having first axial ends fitted to said plate (16) and communicating hydraulically with said first chamber (17), and occluded second axial ends located at said second cover body (5);
at least one membrane (21) housing said tube bundle (15); and
at least one second fitting (11) formed in said central body (3) to permit outflow of the liquid which has undergone a first filtration through the thickness of said capillary fibres, and a second filtration through said membrane (21).

2) A device as claimed in claim 1, characterized by comprising a preferably resin layer (18) formed at said second cover body (5), and in which said second axial ends of said capillary fibres are occluded; said membrane (21) having a first axial end fixed to said plate (16), and a second axial end fixed to said layer (18).

3) A device as claimed in claim 1, characterized in that said central body (3) is cylindrical, and comprises a central portion (6) coaxially housing said membrane (21) and said tube bundle (15) inside said membrane; a first axial end portion (7) closed by said first cover body (4) and housing said plate (16); and a second axial end portion (8) closed by said second cover body (5) and housing said layer (18).

4) A device as claimed in claim 3, characterized in that a second chamber (22) is defined between said tube bundle (15) and the inner wall of said membrane (21); and a third chamber (23) is defined between the outer wall of said membrane (21) and the inner wall of said central body (3), and communicates hydraulically with the outside of said cartridge (2) via said second fitting (11).

5) A device as claimed in claim 4, characterized in that said second fitting (11) is formed in said central body (3), and more specifically at one of said axial end portions (7, 8) of said central body (3).

6) A device as claimed in claim 5, characterized in that said axial end portions (7, 8) of said central body (3) have an inside diameter larger than the inside diameter of said central portion (6) of said central body (3).

7) A device as claimed in claim 1, characterized in that said capillary fibres are made selectively of polysulphone or polyethersulphone or polypropylene.

8) A device as claimed in claim 1, characterized in that said membrane (21) is made selectively of polysulphone or polyethersulphone or polypropylene or PVDF or PTFE.
